(19) United States
(12) Patent Application Publication
(10) Pub. No.: US 2022/0107271 A1
(43) Pub. Date: Apr. 7, 2022

(54) MICROPARTICLE ANALYSIS DEVICE, ANALYSIS DEVICE, ANALYSIS PROGRAM, AND MICROPARTICLE ANALYSIS SYSTEM

(71) Applicant: SONY GROUP CORPORATION, TOKYO (JP)

(72) Inventors: MASAAKI HARA, TOKYO (US); TOMOYUKI UMETSU, KANAGAWA (JP); TOSHIYUKI NISHIHARA, (US)

(21) Appl. No.: 17/310,702

(22) PCT Filed: Jan. 16, 2020
(86) PCT No.: PCT/JP2020/001178

§ 371 Date: Aug. 18, 2021

(30) Foreign Application Priority Data
Feb. 27, 2019 (JP) 2019-034973

(51) Int. Cl. G01N 21/64; G01N 15/14

(52) U.S. Cl. CPC G01N 21/6458; G01N 2015/1006; G01N 15/1459; G01N 15/1429

(57) ABSTRACT

A microparticle analysis device (1) is provided with a light source (16), a two-dimensional photoelectric conversion sensor (28), and a calculation unit (10C). The light source (16) irradiates a microparticle (M) flowing in a flow path (14C) with excitation light (L1). The two-dimensional photoelectric conversion sensor (28) receives fluorescence emitted from the microparticle (M) by a light receiving surface (30) including a plurality of light reception units (32) arranged two-dimensionally, and acquires data of a fluorescence signal including stored charge values of the plurality of light reception units (32), respectively. The calculation unit (10C) calculates an evaluation value including an area that is a total value of a plurality of stored charge values included in the data of the fluorescence signal.

### TECHNICAL FIELD

The present disclosure relates to a microparticle analysis device, an analysis device, an analysis program, and a microparticle analysis system.

### BACKGROUND ART

A technology of analyzing, using fluorescence emitted from a microparticle such as a cell, the microparticle is known. For example, the fluorescence emitted from the microparticle is acquired as a pulse waveform using a photomultiplier tube. Then, a technology of analyzing the microparticle using an area, a height, and a pulse width of the pulse waveform is disclosed (for example, Patent Document 1).

### CITATION LIST

### Patent Document

Patent Document 1: Japanese Patent Application Laid-Open No. 2017-58361

### SUMMARY OF THE INVENTION

### Problems to be Solved by the Invention

However, in a case where fluorescence is received by a two-dimensional photoelectric conversion sensor that outputs stored charge, a pulse waveform of the fluorescence is not acquired. When the pulse waveform is not acquired, the area, height, and pulse width of the pulse waveform are not acquired. For this reason, conventionally, it has been difficult to analyze a microparticle using a fluorescence signal acquired from the two-dimensional photoelectric conversion sensor.

Therefore, the present disclosure proposes a microparticle analysis device, an analysis device, an analysis program, and a microparticle analysis system capable of providing an evaluation value used for analyzing a microparticle using a fluorescence signal acquired from a two-dimensional photoelectric conversion sensor.

### Solutions to Problems

In order to solve the above-described problem, a microparticle analysis device according to an aspect of the present disclosure is provided with a light source that irradiates a microparticle flowing in a flow path with excitation light, a two-dimensional photoelectric conversion sensor that receives fluorescence emitted from the microparticle by a light receiving surface including a plurality of light reception units arranged two-dimensionally and acquires data of a fluorescence signal including stored charge values of a plurality of the light reception units, respectively, and a calculation unit that calculates an evaluation value including an area that is a total value of a plurality of the stored charge values included in the data of the fluorescence signal.

### BRIEF DESCRIPTION OF DRAWINGS

FIG. 1 is a schematic diagram illustrating an example of a microparticle analysis device according to an embodiment of the present disclosure.

FIG. 2 is a schematic diagram illustrating an example of a two-dimensional photoelectric conversion sensor according to the embodiment of the present disclosure.

FIG. 3A is a schematic diagram illustrating an example of a fluorescence signal according to the embodiment of the present disclosure.

FIG. 3B is a schematic diagram illustrating an example of a fluorescence signal according to the embodiment of the present disclosure.

FIG. 4A is a schematic diagram illustrating an example of a fluorescence signal according to the embodiment of the present disclosure.

FIG. 4B is a schematic diagram illustrating an example of a fluorescence signal according to the embodiment of the present disclosure.

FIG. 5A is a schematic diagram illustrating an example of a fluorescence signal according to the embodiment of the present disclosure.

FIG. 5B is a schematic diagram illustrating an example of a fluorescence signal according to the embodiment of the present disclosure.

FIG. 6A is a schematic diagram illustrating an example of a fluorescence signal according to the embodiment of the present disclosure.

FIG. 6B is a schematic diagram illustrating an example of a fluorescence signal according to the embodiment of the present disclosure.

FIG. 7A is a schematic diagram illustrating an example of a fluorescence signal according to the embodiment of the present disclosure.

FIG. 7B is a schematic diagram illustrating an example of a fluorescence signal according to the embodiment of the present disclosure.

FIG. 8A is an explanatory view of an example of connection processing of spot regions according to the embodiment of the present disclosure.

FIG. 8B is an explanatory view of an example of connection processing of spot regions according to the embodiment of the present disclosure.

FIG. 8C is an explanatory view of an example of connection processing of spot regions according to the embodiment of the present disclosure.

FIG. 9 is a distribution chart illustrating a relationship between a maximum value and an area according to the embodiment of the present disclosure.

FIG. 10A is a schematic diagram illustrating an example of a histogram of an area according to the embodiment of the present disclosure.

FIG. 10B is a view illustrating an average value and standard deviation of a peak according to the embodiment of the present disclosure.

FIG. 11 is a flowchart illustrating an example of a flow of information processing according to the embodiment of the present disclosure.

FIG. 12 is a hardware configuration diagram illustrating an example of a computer that implements functions of an analysis device according to the embodiment of the present disclosure.

### MODE FOR CARRYING OUT THE INVENTION

Hereinafter, an embodiment of the present disclosure is described in detail with reference to the drawings. Note that, in the following embodiments, the same parts are denoted by the same reference signs, and the description thereof is not repeated.

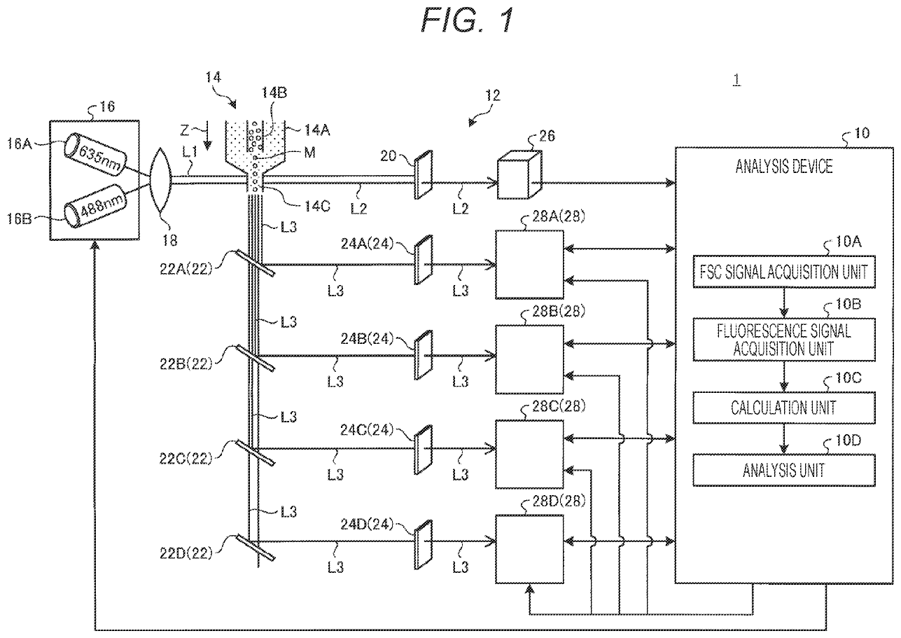

FIG. 1 is a schematic diagram illustrating an example of a microparticle analysis device 1 of this embodiment.

The microparticle analysis device 1 is provided with an analysis device 10 and a measurement unit 12.

The measurement unit 12 is a system that receives fluorescence emitted from the microparticle and outputs a fluorescence signal to the analysis device 10. The measurement unit 12 or the microparticle analysis device 1 including the measurement unit 12 is applied to, for example, a flow cytometer (FCM).

The microparticle is a particle to be analyzed. “Micro-” is intended to mean 1,000 μm or smaller. The microparticle is, for example, an inorganic particle, a microorganism, a cell, a liposome, a red blood cell, a white blood cell, and a platelet in blood, a vascular endothelial cell, a microcell piece of epithelial tissue and the like.

In the present invention, “microparticles” broadly include bio-related microparticles such as cells, microorganisms, and liposomes, synthetic particles such as latex particles, gel particles, and industrial particles or the like.

The bio-related microparticles include chromosomes forming various cells, liposomes, mitochondria, organelles (cell organelles) and the like. The cells include animal cells (such as blood cells) and plant cells. The microorganisms include bacteria such as Escherichia coli, viruses such as tobacco mosaic virus, fungi such as yeast and the like.

Moreover, the bio-related microparticles may also include bio-related polymers such as nucleic acids, proteins, and complexes thereof. Furthermore, the industrial particles may be, for example, an organic or inorganic polymer material, metal and the like. The organic polymer material includes polystyrene, styrene/divinylbenzene, polymethyl methacrylate and the like. The inorganic polymer material includes glass, silica, a magnetic material and the like. Metal includes gold colloid, aluminum and the like. In general, shapes of the microparticles are generally spherical, but they may be non-spherical, and its size, mass and the like are also not especially limited.

The measurement unit 12 is provided with a flow path system 14, a light source 16, and a two-dimensional photoelectric conversion sensor 28. A condenser lens 18, optical filters 20 and 22, an optical filter 24, and a photodiode 26 may further be provided.

The flow path system 14 is provided with a cylindrical flow cell 14A. Inside the flow cell 14A, a cylindrical tube 14B is arranged coaxially with the flow cell 14A. Note that the flow path system 14 may use a chip including a micro flow path in place of the flow cell.

Between the flow cell 14A and the tube 14B, a sample liquid and a sheath liquid flow in an arrow Z direction in the drawing and merge in a flow path 14C. Microparticles M flow in the flow path 14C along a flow of the sample liquid in a state of being arranged in a line.

The light source 16 irradiates the microparticle M flowing in the flow path 14C with excitation light L1. The excitation light L1 is light in a wavelength region that excites fluorescence by which the microparticle M to be analyzed is stained.

The light source 16 may be any light source that emits the excitation light L1. FIG. 1 illustrates, as an example, a configuration in which the light source 16 includes a light source 16A and a light source 16B. The light source 16A and the light source 16B emit the excitation light L1 in different wavelength regions. For example, the light source 16A is a light source that emits the excitation light L1 of a wavelength of 635 nm. Furthermore, the light source 16B is a light source that emits the excitation light L1 of a wavelength of 488 nm. Note that the number of light sources forming the light source 16 is not limited to two. Furthermore, the wavelength of the excitation light L1 emitted from the light source 16 is not limited to that described above. Furthermore, an optical axis of the light source 16A and an optical axis of the light source 16B may be the same with or different from each other.

The excitation light L1 emitted from the light source 16 is condensed in the flow path 14C by the condenser lens 18. Therefore, the microparticle M passing through the flow path 14C is irradiated with the excitation light L1.

A portion in which the microparticle M passes through the excitation light L1 is referred to as an interrogation area, a laser intercept, or a light detection unit.

When the microparticle M is irradiated with the excitation light L1, the microparticle M emits scattered light L2 and fluorescence L3. The scattered light is at least one of forward scattered light (FSC), side scattered light, or backscattered light.

The forward scattered light L2 is received by the photodiode 26 via the optical filter 20. The optical filter 20 is the optical filter that selectively transmits the forward scattered light L2.

The photodiode 26 receives the forward scattered light L2 and outputs an FSC signal to the analysis device 10. The FSC signal is a signal indicating that the microparticle M passes through the interrogation point. Here, the forward scattered light L2 is light of a large light amount. Therefore, the photodiode 26 may detect the passage of the microparticle M by receiving the forward scattered light L2 and output the FSC signal to the analysis device 10.

In contrast, the fluorescence L3 reaches the two-dimensional photoelectric conversion sensor 28 via the dichroic mirror 22 and the optical filter 24, and is received by the two-dimensional photoelectric conversion sensor 28. Note that the fluorescence L3 is made parallel light by the condenser lens, and then reaches a light receiving surface of the two-dimensional photoelectric conversion sensor 28 by a multimode optical fiber via the dichroic mirror 22 and the optical filter 24.

Note that, for fluorescence detection by the flow cytometer, in addition to a method of selecting a plurality of lights in discontinuous wavelength regions using a wavelength selection element such as a filter and measuring intensity of light in each wavelength region, there also is a method of measuring intensity of light in a continuous wavelength region as fluorescence spectrum. In a spectrum-type flow cytometer capable of measuring the fluorescence spectrum, the fluorescence emitted from the microparticle is dispersed using a spectroscopic element such as a prism or a grating. Then, the dispersed fluorescence is detected using a light receiving element array in which a plurality of light receiving elements of different detection wavelength regions is arranged. As the light receiving element array, a PMT array or a photodiode array in which the light receiving elements such as PMTs or photodiodes are one-dimensionally arranged, or that obtained by arranging a plurality of independent detection channels such as two-dimensional light receiving elements such as CCDs or CMOSs is used.

FIG. 1 illustrates a mode in which the measurement unit 12 is provided with a plurality of two-dimensional photoelectric conversion sensors 28 (two-dimensional photoelectric conversion sensors 28A to 28D) as an example. The plurality of two-dimensional photoelectric conversion sensors 28 receives the fluorescence L3 in different wavelength regions.

The dichroic mirror 22 and the optical filter 24 are provided on an upstream side in an incident direction of the fluorescence L3 of each of the plurality of two-dimensional photoelectric conversion sensors 28.

The dichroic mirror 22 reflects the fluorescence L3 in a specific wavelength region and transmits the fluorescence L3 of a wavelength other than the wavelength region. The optical filter 24 transmits the fluorescence L3 in the specific wavelength region.

In this embodiment, the measurement unit 12 is provided with dichroic mirrors 22A to 22D and optical filters 24A to 24D corresponding to the two-dimensional photoelectric conversion sensors 28A to 28D, respectively.

The fluorescence L3 emitted from the microparticle M is reflected by the dichroic mirrors 22A to 22D and transmitted through the optical filters 24A to 24D to reach the two-dimensional photoelectric conversion sensors 28A to 28D, respectively, according to the wavelength regions.

Therefore, the two-dimensional photoelectric conversion sensors 28A to 28D receive the fluorescence L3 in different wavelength regions. Note that it is only required that the two-dimensional photoelectric conversion sensors 28A to 28D receive the fluorescence L3 in the different wavelength regions. Therefore, an optical system that allows each of the two-dimensional photoelectric conversion sensors 28A to 28D to receive the fluorescence L3 is not necessarily configured as described above. For example, it is also possible to configure that the two-dimensional photoelectric conversion sensors 28A to 28D receive the fluorescence L3 in the different wavelength regions by arranging a spectroscope.

Note that the number of two-dimensional photoelectric conversion sensors 28 provided on the microparticle analysis device 1 may be one or more, and is not limited to four.

Furthermore, hereinafter, in a case where the plurality of two-dimensional photoelectric conversion sensors 28 (two-dimensional photoelectric conversion sensors 28A to 28D) is collectively described, it is simply referred to as the two-dimensional photoelectric conversion sensor 28.

The two-dimensional photoelectric conversion sensor 28 receives the fluorescence L3 emitted from the microparticle M and outputs an image of the fluorescence signal. The two-dimensional photoelectric conversion sensor 28 is, for example, a complementary metal-oxide semiconductor (CMOS) image sensor or a charge coupled device (CCD) image sensor.

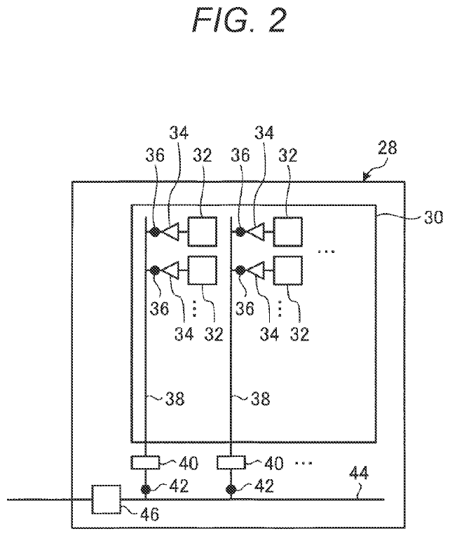

FIG. 2 is a schematic diagram illustrating an example of a configuration of the two-dimensional photoelectric conversion sensor 28. FIG. 2 illustrates the CMOS image sensor as an example.

The two-dimensional photoelectric conversion sensor 28 is a sensor in which a plurality of light reception units 32 is two-dimensionally arranged along a light receiving surface 30 being a two-dimensional plane. Furthermore, the two-dimensional photoelectric conversion sensor 28 stores charge and outputs the image of the fluorescence signal according to the stored charge. Note that a two-dimensional arrangement indicates that the plurality of light reception units 32 is arranged in two directions orthogonal to each other on the light receiving surface 30.

The light reception unit 32 is a photodiode. The light reception unit 32 converts the received fluorescence L3 into the charge to store. The stored charge is converted into a voltage and amplified by an amplifier 34. The amplified voltage is transferred to a vertical signal line 38 for each line by on/off control of a switch 36. The voltage transferred to the vertical signal line 38 is temporarily stored in a column circuit 40 arranged for each vertical signal line 38. The voltage stored in the column circuit 40 is transmitted to a horizontal signal line 44 by on/off control of a switch 42, and is converted from an analog signal to a digital signal by an analog/digital (A/D) converter 46 to be output as the image of the fluorescence signal.

The image of the fluorescence signal is an image including a stored charge value of each of the plurality of light reception units 32 provided on the two-dimensional photoelectric conversion sensor 28. The stored charge value indicates a charge value that is stored. That is, the image of the fluorescence signal is an image indicating the charge value stored in each of the plurality of light reception units 32. Note that at least two or more stored charge values are referred to as data of the fluorescence signal. That is, even data other than an “image” corresponds to the “data of the fluorescence signal” as long as the data includes at least two or more charge values. Therefore, the image of the fluorescence signal corresponds to an example of the data of the fluorescence signal.

Note that it is assumed that the light reception unit 32 is provided for every pixel or every plurality of pixels. In this case, the image of the fluorescence signal is an image in which the stored charge value is defined for each pixel corresponding to each of the plurality of light reception units 32. In this case, the stored charge value corresponds to a pixel value.

With reference to FIG. 1 again, the description is continued. Next, the analysis device 10 is described. The analysis device 10 is an example of an information processing device. The analysis device 10 analyzes the fluorescence signal.

The analysis device 10 is connected to the photodiode 26, the two-dimensional photoelectric conversion sensor 28 (two-dimensional photoelectric conversion sensors 28A to 28D), and the light source 16 so as to be able to transmit and receive data or signals.

The analysis device 10 is provided with an FSC signal acquisition unit 10A, a fluorescence signal acquisition unit 10B, a calculation unit 10C, and an analysis unit 10D.

A part or all of the FSC signal acquisition unit 10A, the fluorescence signal acquisition unit 10B, the calculation unit 10C, and the analysis unit 10D may be implemented by allowing a processing device such as a central processing unit (CPU) to execute a program, that is, may be implemented by software, may be implemented by hardware such as an integrated circuit (IC), or may be implemented by using software and hardware in combination, for example.

The FSC signal acquisition unit 10A acquires the FSC signal from the photodiode 26. The FSC signal acquisition unit 10A detects that the microparticle M passes through the interrogation point by acquiring the FSC signal.

The fluorescence signal acquisition unit 10B acquires the fluorescence signal from the two-dimensional photoelectric conversion sensor 28. When the FSC signal acquisition unit 10A detects that the microparticle M passes through the integration point, the fluorescence signal acquisition unit 10B outputs a switch control signal to the two-dimensional photoelectric conversion sensor 28. The switch control signal is a signal for reading the stored charge value of each of the plurality of light reception units 32 by controlling the switch 36 and the switch 42 of the two-dimensional photoelectric conversion sensor 28. For example, the switch control signal is indicated by a pulse signal including trailing indicating read start and rising indicating storage start. Upon receiving the switch control signal from the fluorescence signal acquisition unit 10B, the two-dimensional photoelectric conversion sensor 28 outputs the image of the fluorescence signal being the stored charge value of each of the plurality of light reception units 32 to the analysis device 10.

Therefore, the image of the fluorescence signal is an image indicating the stored charge value stored in each of the light reception units 32 in a period in which the microparticle M passes through the integration point.

The fluorescence signal acquisition unit 10B acquires the images of the fluorescence signals of the different wavelengths from the plurality of two-dimensional photoelectric conversion sensors 28 (two-dimensional photoelectric conversion sensors 28A to 28D) each time it is detected that the microparticle M passes through the integration point.

Note that, in order to simplify the description, a mode in which the image of the fluorescence signal is acquired from one two-dimensional photoelectric conversion sensor 28 (for example, the two-dimensional photoelectric conversion sensor 28A) is hereinafter described as an example. Note that similar processing may be executed also in a case where the image of the fluorescence signal is acquired from each of the plurality of two-dimensional photoelectric conversion sensors 28.

The calculation unit 10C calculates an evaluation value using the data of the fluorescence signal. As described above, in this embodiment, the calculation unit 10C calculates the evaluation value using the image of the fluorescence signal.

The evaluation value includes at least one of an area, a maximum value, a saturation degree, or a width.

The area indicates a total value of a plurality of stored charge values included in the image of the fluorescence signal. The area is used as a value for deriving a type or a size of the microparticle M. The calculation unit 10C reads the stored charge value for each pixel (light reception unit 32) forming the image of the fluorescence signal that is the fluorescence signal, and calculates the total value of the plurality of stored charge values. The calculation unit 10C calculates the calculated total value as the area.

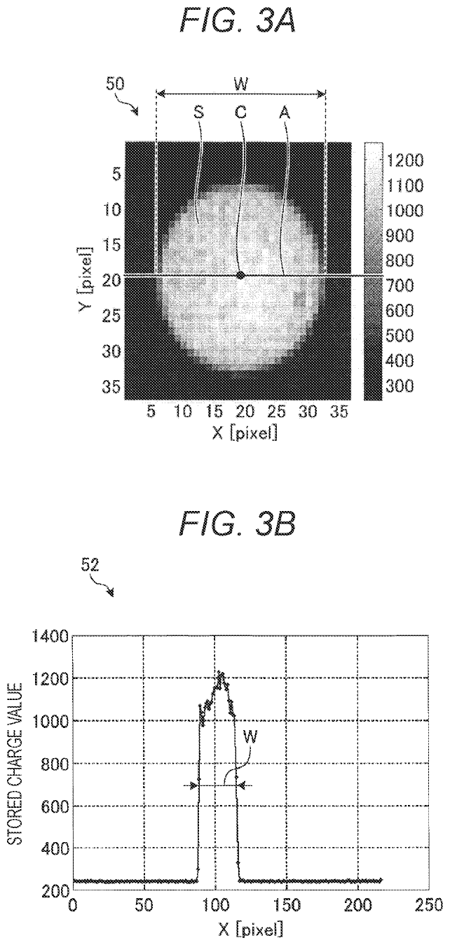

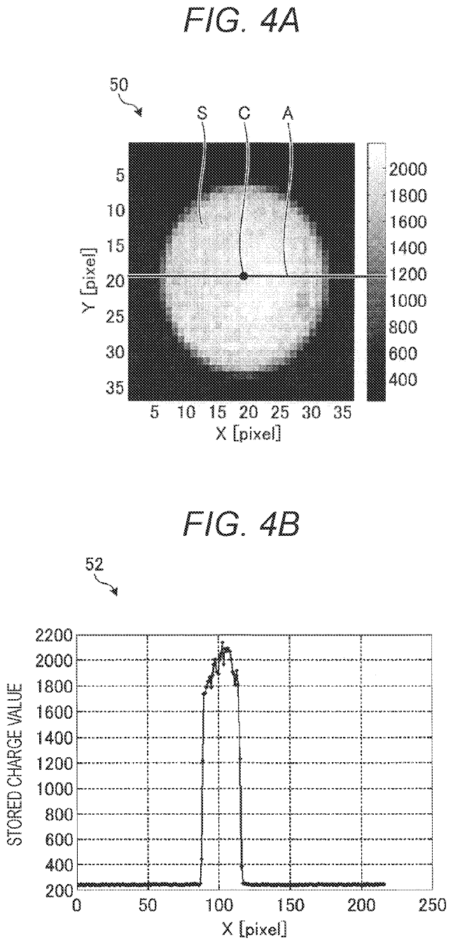

FIGS. 3A and 3B are schematic diagrams illustrating an example of an image 50 of the fluorescence signal. FIGS. 3A and 3B illustrates an example of the image 50 of the fluorescence signal acquired by the two-dimensional photoelectric conversion sensor 28 of a frame rate of 480 fps by allowing 8 Peak Rainbow beads manufactured by Spherotech, Inc. to flow through the flow path system 14. Furthermore, FIGS. 4A to 7B to be described later also illustrate examples of the image 50 of the fluorescence signal acquired under a similar condition (to be described later in detail).

FIG. 3A is the schematic diagram illustrating an example of the image 50 of the fluorescence signal. FIG. 3A illustrates an enlarged image of a 36×36 pixel portion at the center of an entire 326×216 pixel image. In the example illustrated in FIG. 3A, the fluorescence L3 emitted from the microparticle M is incident on the light receiving surface 30 in a circular shape of a diameter of 30 pixels. FIG. 3B is a diagram illustrating the stored charge values of the respective pixels arranged along a line that crosses the image 50 of the fluorescence signal. In FIG. 3B, a position on the line is plotted along the abscissa, and the stored charge value is plotted along the ordinate.

The calculation unit 10C calculates the total value of the stored charge values of the pixels forming the image 50 of the fluorescence signal to calculate the area.

Note that the calculation unit 10C may also calculate, as the area, a total value of subtraction results obtained by subtracting a predetermined offset value from each of the plurality of stored charge values included in the image 50 of the fluorescence signal.

The offset value is a value of an offset voltage of the two-dimensional photoelectric conversion sensor 28. In detail, the offset value is the stored charge value output from the light reception unit 32 of the two-dimensional photoelectric conversion sensor 28 when the fluorescence L3 is not incident on the two-dimensional photoelectric conversion sensor 28. The offset value is, for example, 240, but is not limited to this value. The calculation unit 10C may acquire the value of the offset voltage of the two-dimensional photoelectric conversion sensor 28 in advance and use the same for calculating the area.

Furthermore, the calculation unit 10C may further calculate, as the area, a total value of multiplication results obtained by multiplying the above-described subtraction results by a predetermined conversion gain. That is, the calculation unit 10C subtracts the above-described offset value from the stored charge value of each of the plurality of pixels forming the image 50 of the fluorescence signal and then multiplies the subtraction results by the above-described conversion gain.

Then, the total value of the multiplication results of the plurality of pixels included in the image 50 of the fluorescence signal is calculated as the area.

Note that the conversion gain may be set in advance according to the two-dimensional photoelectric conversion sensor 28. The conversion gain may be either a value smaller than one or a value equal to or larger than one.

For example, it is assumed that the A/D converter 46 of the two-dimensional photoelectric conversion sensor 28 is a 12-bit A/D converter. Then, it is assumed that the stored charge value (LSB) A/D converted at 12 bits by the two-dimensional photoelectric conversion sensor 28 corresponds to 0.6 photoelectrons. In this case, the conversion gain may be set to 0.6 [e⁻/LSB]. Note that in a case where a unit of the conversion gain is set to [e⁻/LSB], a unit of the area is [e⁻]. Note that the unit of the conversion gain and the unit of the area may be set according to an analysis content, and are not limited to these units.

Note that the subtraction of the offset value and the multiplication of the conversion gain may be executed on a side of the analysis unit 10D.

Next, calculation of the maximum value is described. The calculation unit 10C calculates the maximum value out of the plurality of stored charge values included in the image 50 of the fluorescence signal. The calculation unit 10C may read the plurality of stored charge values included in the image 50 of the fluorescence signal and calculate the stored charge value of the largest value as the maximum value.

Next, calculation of the saturation degree is described. The calculation unit 10C calculates the saturation degree from the image 50 of the fluorescence signal. The saturation degree indicates a rate of the number of stored charge values indicating the maximum charge value that may be output from the light reception unit 32 included in the image 50 of the fluorescence signal. The maximum stored charge value that may be output from the light reception unit 32 is sometimes referred to as a saturation value. In other words, the saturation degree indicates a rate of the number of pixels indicating the stored charge value that coincides with the saturation value to the total number of pixels (total number of pixels) forming the image 50 of the fluorescence signal.

The saturation value of the light reception unit 32 varies depending on the two-dimensional photoelectric conversion sensor 28. The calculation unit 10C may acquire information indicating the saturation value in advance from the two-dimensional photoelectric conversion sensor 28 and use the same for calculating the saturation degree.

For example, it is assumed that the A/D converter 46 of the two-dimensional photoelectric conversion sensor 28 is a 12-bit A/D converter. In this case, a dynamic range of the two-dimensional photoelectric conversion sensor 28 is 0 to 4095, and the saturation value of the two-dimensional photoelectric conversion sensor 28 is 4095.

Note that the calculation unit 10C may calculate the evaluation value for each spot region S included in the image 50 of the fluorescence signal. That is, the calculation unit 10C may calculate the area, the maximum value, and the saturation degree for each spot region S included in one image 50 of the fluorescence signal.

The spot region S is one or a plurality of fluorescence receiving regions in the image 50 of the fluorescence signal. In detail, the spot region S is a light receiving region of the fluorescence L3 emitted from the microparticle M in the image 50 of the fluorescence signal.

The spot region S included in the image 50 of the fluorescence signal is the light receiving region of the fluorescence L3 emitted from one microparticle M. It is also possible to configure to acquire a plurality of fluorescence signals corresponding to four L3 in FIG. 1 by one two-dimensional photoelectric conversion sensor. In this case, the image 50 of the fluorescence signal includes a plurality of spot regions S.

Therefore, the calculation unit 10C preferably calculates the area, the maximum value, and the saturation degree for each spot region S.

Note that a position of the spot region S in the image 50 of the fluorescence signal is fixed. This is because, when a plurality of fluorescence signals is incident on one two-dimensional photoelectric conversion sensor, the fluorescence signals are arranged so as not to overlap with each other.

Therefore, the calculation unit 10C may specify a predetermined region in the image 50 of the fluorescence signal as the spot region S and use the same for calculating the evaluation value. Note that the calculation unit 10C may specify a portion in which a difference in stored charge value between adjacent pixels is equal to or larger than a threshold in the image 50 of the fluorescence signal as an edge of the spot region S and specify a region in the edge as the spot region S. Furthermore, the calculation unit 10C may specify, as the spot region S, a region of a lowest stored charge value regarded as receiving the fluorescence L3 or larger in the image 50 of the fluorescence signal.

Next, calculation of the width is described. The calculation unit 10C calculates, as the width, the number of pixels indicating the stored charge value equal to or larger than a first threshold out of a plurality of pixels arranged along a straight line A passing through the center C of the spot region S of the image 50 of the fluorescence signal. The center C of the spot region S indicates the center position of the spot region S.

As the first threshold, the lowest value of the stored charge value for determining that the fluorescence L3 is received may be determined in advance. For example, the first threshold is the stored charge value “400”, but is not limited to this value. That is, the calculation unit 10C calculates, as the width, a maximum length of consecutive pixels of the threshold or larger included in the image 50 of the fluorescence signal (refer to a width W in FIGS. 3A and 3B).

Note that an extending direction of the straight line A used when calculating the width is preferably a direction that passes through the center C of the spot region S and coincides with a reading direction of the image 50 of the fluorescence signal.

As described with reference to FIG. 2, the image 50 of the fluorescence signal is acquired by sequentially reading the stored charge values of a plurality of light reception units 32 in an arrangement direction of a plurality of vertical signal lines 38 (the extending direction of the horizontal signal line 44). Therefore, a scanning direction being the reading direction coincides with the arrangement direction of the plurality of vertical signal lines 38, that is, the reading direction in the extending direction of the horizontal signal line 44.

In this manner, the calculation unit 10C calculates the evaluation value each time the image 50 of the fluorescence signal is acquired.

FIGS. 4A to 6B illustrate other examples of the image 50 of the fluorescence signal. As in FIG. 3A, FIGS. 4A, 5A, and 6A illustrate an enlarged image of a 36×36 pixel portion at the center of the entire 326×216 pixel image. FIGS. 4B, 5B, and 6B are diagrams illustrating the stored charge values of the respective pixels arranged along the line that crosses the image 50 of the fluorescence signal. In FIGS. 4B, 5B, and 6B, a position on the line is plotted along the abscissa, and the stored charge value is plotted along the ordinate.

FIGS. 4A and 4B are schematic diagrams illustrating an example of the image 50 of a bright fluorescence signal. FIGS. 4A and 4B illustrate the example of the image 50 of the fluorescence signal with the area of “5.42×10⁵”, the maximum value of “2192”, the width of “28”, and the saturation degree of “0”%. Note that the above-described maximum value “2192” is, for example, a value of about ½ of the dynamic range (for example, 0 to 4095) of the two-dimensional photoelectric conversion sensor 28.

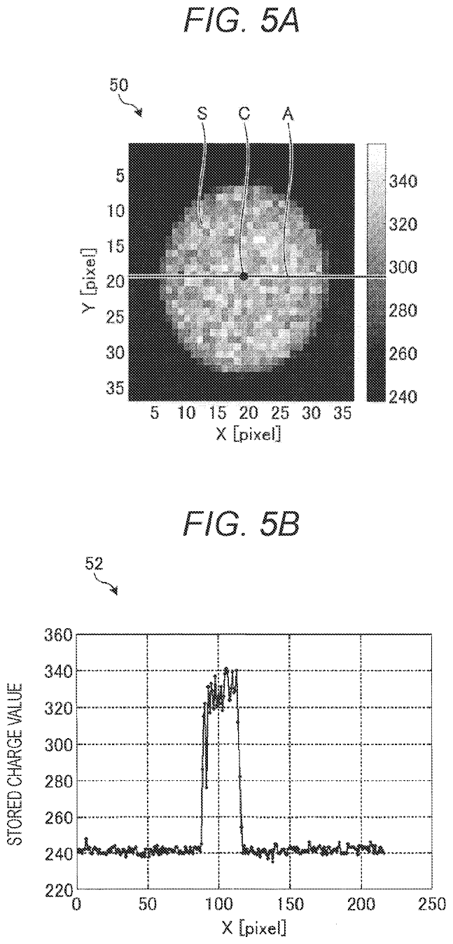

FIGS. 5A and 5B are schematic diagrams illustrating an example of the image 50 of a dark fluorescence signal. FIGS. 5A and 5B illustrate the example of the image 50 of the fluorescence signal with the area of “2.64×10⁴”, the maximum value of “356”, the width of “0”, and the saturation degree of “0”%. Note that the above-described maximum value “356” is a value of about 1/10 of the dynamic range (for example, 0 to 4095) of the two-dimensional photoelectric conversion sensor 28. Note that the width was “0” because no stored charge value exceeding the stored charge value “400” being an example of the first threshold was included.

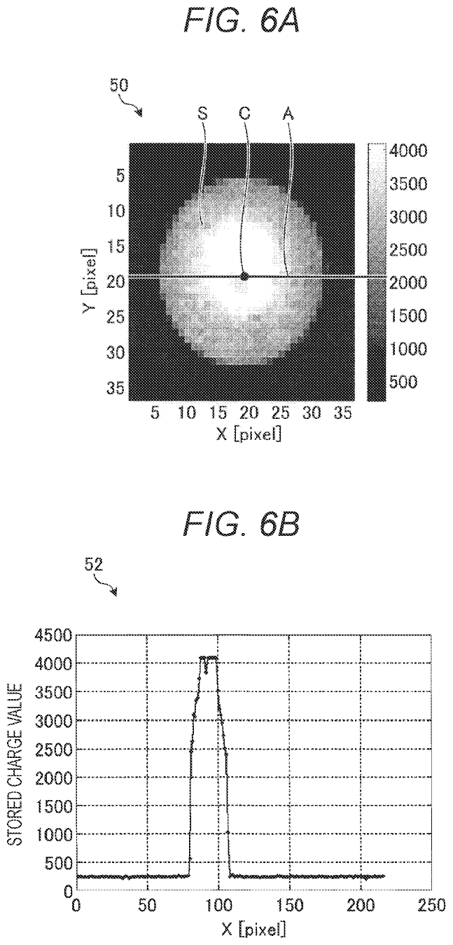

FIGS. 6A and 6B are schematic diagrams illustrating an example of the fluorescence signal with a high saturation degree. FIGS. 6A and 6B illustrate the example of the image 50 of the fluorescence signal with the area of “9.88×10⁵”, the maximum value of “4095”, and the saturation degree of “105/(326×216)”%.

Note that FIGS. 4A and 4B, FIGS. 5A and 5B, and FIGS. 6A and 6B are the examples of the images 50 of the fluorescence signals of different types of microparticles M.

As illustrated in FIGS. 4A to 6B, a range and variation of the stored charge values included in the image 50 of the fluorescence signal vary depending on the type of the microparticle M. Therefore, the calculation unit 10C may calculate the evaluation value of each of the microparticles M by calculating the evaluation value using the image 50 of the fluorescence signal.

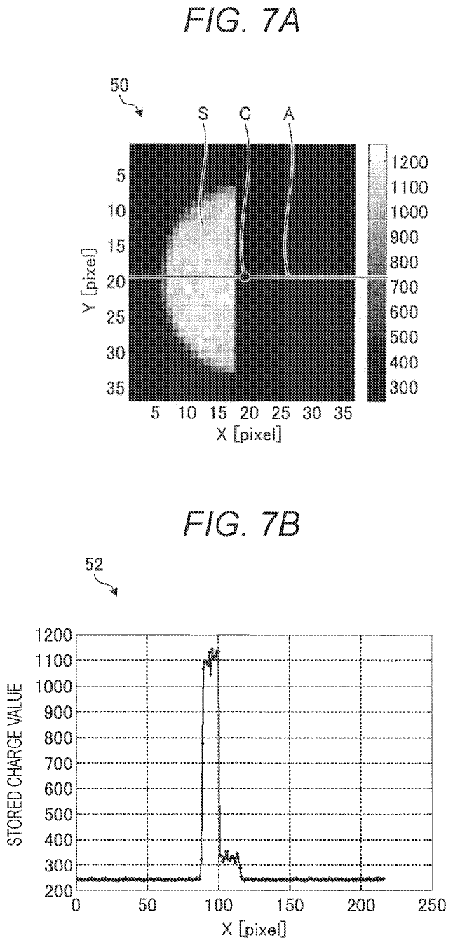

Here, there is a case where a missing part occurs in a part of the spot region S included in the image 50 of the fluorescence signal. FIGS. 7A and 7B are schematic diagrams illustrating an example of the fluorescence signal including the spot region S in which the missing part occurs.

As described above, the image 50 of the fluorescence signal is a signal acquired each time the microparticle M passes through the interrogation point. Such fragment image should not originally occur in a system that acquires an image in accordance with a timing at which the microparticle M passes as described above, but in a two-dimensional photoelectric conversion sensor that acquires an image at a constant cycle, such fragment image might occur, and the fluorescence signal is sometimes acquired across two images.

Therefore, in a case where the above-described calculated width is equal to or smaller than a second threshold, the calculation unit 10C determines that the missing part occurs in the spot region S. As the second threshold, a lower limit value of the width for determining as the spot region S corresponding to one microparticle M may be determined.

When determining that the above-described calculated width is equal to or smaller than the second threshold, the calculation unit 10C executes connection processing of the spot regions S. In detail, the calculation unit 10C generates a connected spot region obtained by connecting the spot region S used for calculating the width and the spot region S having a width equal to or smaller than the second threshold included in the image 50 of the fluorescence signal acquired continuous to the image 50 of the fluorescence signal used for calculating the width in chronological order.

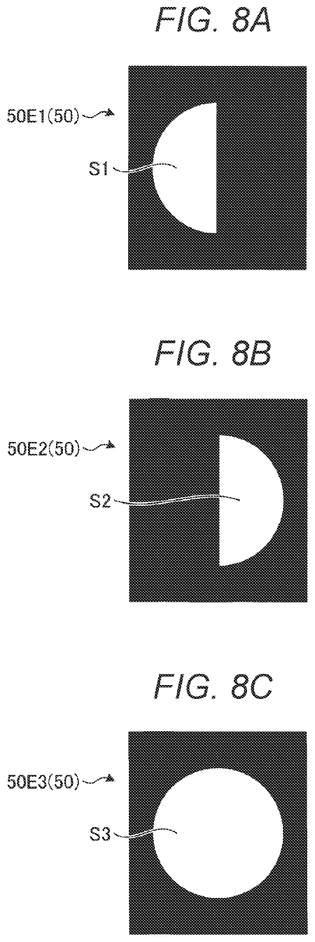

FIGS. 8A, 8B, and 8C are explanatory views of an example of the connection processing of the spot regions S by the calculation unit 10C.

For example, it is assumed that the fluorescence signal acquisition unit 10B continuously acquires an image 50E1 of the fluorescence signal including a spot region S1 of the width equal to or smaller than the second threshold and an image 50E2 of the fluorescence signal including a spot region S2 of the width equal to or smaller than the second threshold in chronological order (refer to FIGS. 8A and 8B). Furthermore, it is assumed that a total value of the widths of the spot regions S is equal to or larger than a reference value of the width of the spot region S without missing part (for example, a width of “28”). In this case, the calculation unit 10C generates a connected spot region S3 by connecting the spot region S1 and the spot region S2 in the above-described scanning direction. A known image synthesizing technology may be used to generate the connected spot region S3.

Then, the calculation unit 10C may recalculate the evaluation value including at least one of the area, the maximum value, the saturation degree, or the width using the connected spot region S3 that is connected in place of the spot region S (spot region S1 and spot region S2) having the width smaller than the second threshold.

Note that the calculation unit 10C may exclude the spot region S of the width smaller than the second threshold from the analysis target. In this case, the calculation unit 10C may be configured not to execute the connection processing of the spot region S and not to output the evaluation value of the spot region S to the analysis unit 10D described later.

With reference to FIG. 1 again, the description is continued.

The analysis unit 10D analyzes the microparticle M on the basis of the evaluation value.

In detail, the analysis unit 10D analyzes at least one of the type or the size of the microparticle M using the area included in the evaluation value.

For example, it is assumed that the calculation unit 10C calculates the evaluation value for each spot region S (that is, for each type of fluorescence). In this case, the calculation unit 10C specifies in advance a correlation between the area of each of a plurality of types of fluorescence and the type and size of the microparticle M. Then, the calculation unit 10C may analyze the type and size of the microparticle M by specifying the type and size of the microparticle M indicating the correlation the same as or similar to that of the calculated evaluation value.

Note that, an example in which the calculation unit 10C detects the missing part of the spot region S on the basis of the width included in the evaluation value is described above. However, the analysis unit 10D may also detect the missing part of the spot region S on the basis of the width included in the evaluation value. In this case, as is the case with the calculation unit 10C, the analysis unit 10D may detect the missing part of the spot region S and execute generation of the connected spot region and recalculation of the evaluation value.

Furthermore, the analysis unit 10D controls at least one of an irradiation light amount of the excitation light L1 or an analog/digital conversion gain of the two-dimensional photoelectric conversion sensor 28 on the basis of the evaluation value.

In detail, the analysis unit 10D controls at least one of the light source 16 or the two-dimensional photoelectric conversion sensor 28 using the area, the maximum value, and the saturation degree included in the evaluation value.

Specifically, the analysis unit 10D generates a distribution chart indicating a relationship between the maximum value and the area using the evaluation value of each of a plurality of microparticles M.

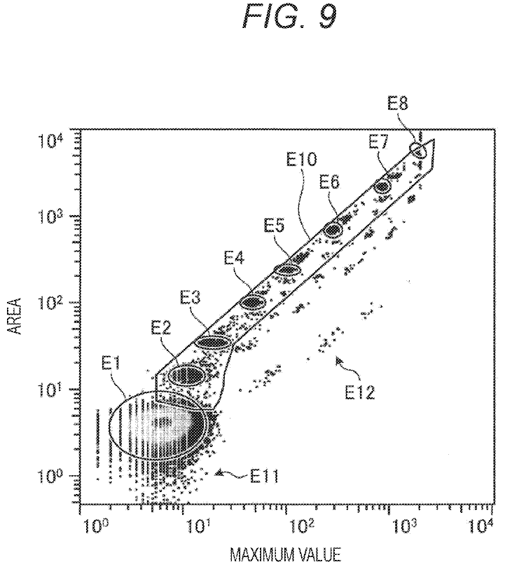

FIG. 9 is the distribution chart illustrating the relationship between the maximum value and the area. In FIG. 9, the maximum value is plotted along the abscissa, and the area is plotted along the ordinate. The analysis unit 10D plots each of a plurality of evaluation values in a position indicating the maximum value and the area indicated in the evaluation value in the distribution chart.

Then, as illustrated in FIG. 9, a plurality of plots indicating the plurality of evaluation values is classified into a plurality of groups (for example, groups E1 to E8) according to the position indicated by the correlation between the maximum value and the area.

Among the plots belonging to each of the groups E1 to E8, the plots belonging to the group E1 in which both the maximum value and the area are located within a range of a third threshold or smaller are the plots indicating the evaluation value of the image 50 of the fluorescence signal not including the spot region S. As the third threshold, a lower limit value for determining as the image 50 of the fluorescence signal not including the spot region S being the light receiving region of the fluorescence L3 may be determined in advance.

As illustrated in FIG. 9, the relationship between the maximum value and the area included in each of the plurality of evaluation values has a specific correlation. In the example illustrated in FIG. 9, the relationship between the area and the maximum value shows linearity. However, there is a case where there is the plot indicating the evaluation value in a position deviated from the correlation showing the linearity.

Therefore, the analysis unit 10D preferably sets, among the plurality of evaluation values, the evaluation value in which at least one of the maximum value or the area indicates a value within a predetermined range as the analysis target and excludes the evaluation value indicating a value outside the range from the analysis target.

For example, the analysis unit 10D sets the evaluation values in a group E10 including the plots belonging to the groups E1 to E8 showing linearity as the analysis targets. Then, the analysis unit 10D excludes the evaluation values located in a range other than the group E10 (for example, groups E11 and E12) from the analysis target. Therefore, the analysis unit 10D may improve analysis accuracy.

Then, the analysis unit 10D calculates a histogram of the area and a standard deviation of a peak represented by the histogram using the plurality of evaluation values to be analyzed.

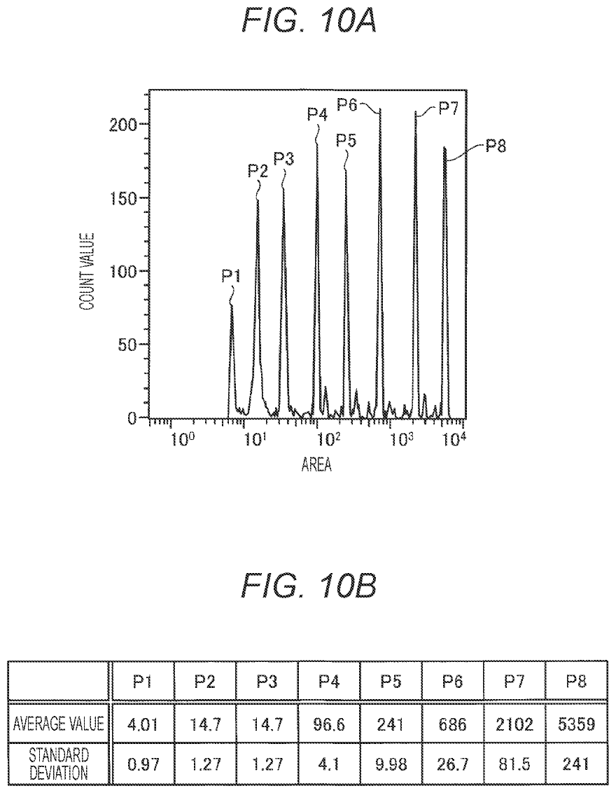

FIG. 10A is a schematic diagram illustrating an example of the histogram of the area. In FIG. 10A, the area is plotted along the abscissa, and a count value of the evaluation value is plotted along the ordinate.

In FIG. 10A, peaks P1 to P8 correspond to the groups E1 to E8 of the evaluation values in FIG. 9, respectively. FIG. 10B is a view illustrating an average value and standard deviation (rSD) of each peak.

Then, the analysis unit 10D controls at least one of the irradiation light amount of the excitation light L1 or the analog/digital conversion gain of the two-dimensional photoelectric conversion sensor 28 using the correlation between the maximum value and the area, the histogram of the area, and the standard deviation of the peak of the plurality of evaluation values to be analyzed.

Here, the smaller the maximum value indicated in the evaluation value, the worse a signal-to-noise ratio (SN ratio) of the area indicated in the evaluation value. In order to increase the maximum value included in the evaluation value in order to reduce noise, at least one of an increase in the irradiation light amount of the excitation light L1 or an increase in the analog/digital gain of the two-dimensional photoelectric conversion sensor 28 is required.

However, the larger the maximum value included in the evaluation value, the higher the saturation degree. The higher the saturation degree, the worse the linearity indicating the correlation between the area and the maximum value. Specifically, in a case of the distribution chart illustrated in FIG. 9, the number of plots belonging to the group E8 being the group of the plots indicating the evaluation value of the highest saturation degree increases, and the linearity is impaired.

In order to decrease the saturation degree of the evaluation value, at least one of a decrease in the irradiation light amount of the excitation light L1 or a decrease in the analog/digital gain of the two-dimensional photoelectric conversion sensor 28 is required.

However, when the irradiation light amount of the excitation light L1 is excessively decreased or the analog/digital gain of the photodiode 26 is excessively decreased, an increase in noise, an increase in the image 50 of the fluorescence signal not including the spot region S or the like occurs.

Furthermore, the larger the standard deviation of each of the peaks P1 to P8 corresponding to the groups E1 to E8 of the evaluation values, respectively, the lower the signal-to-noise ratio (SN ratio) included in the image 50 of the fluorescence signal.

Therefore, it is preferable to control at least one of the irradiation light amount of the excitation light L1 or the analog/digital gain of the two-dimensional photoelectric conversion sensor 28 so that these standard deviations have smaller values.

Therefore, the analysis unit 10D controls at least one of the irradiation light amount of the excitation light L1 or the analog/digital gain of the two-dimensional photoelectric conversion sensor 28 on the basis of the evaluation value acquired from the calculation unit 10C so that the evaluation value satisfying at least one of the above-described conditions is acquired. At least one of the above-described conditions is at least one of an increase in the maximum value included in the evaluation value, a decrease in the saturation degree included in the evaluation value, an increase in difference between the evaluation value calculated from the image 50 of the fluorescence signal not including the spot region S and the evaluation value calculated from the image 50 of the fluorescence signal including the spot region S, maintenance of linearity of the correlation between the area and the maximum value, or a decrease in the standard deviation of the peak of the histogram of the area included in the evaluation value.

Note that the analysis unit 10D preferably controls at least one of the irradiation light amount of the excitation light L1 or the analog/digital gain of the two-dimensional photoelectric conversion sensor 28 so that the evaluation value satisfying two or more of the above-described conditions may be acquired.

Note that, in a case where the two-dimensional photoelectric conversion sensor 28 includes an amplifier, the analysis unit 10D may control at least one of the analog/digital gain or an amplification gain.

The analysis unit 10D calculates a measurement condition control signal for controlling at least one of the light source 16 or the two-dimensional photoelectric conversion sensor 28 so as to satisfy at least one of the above-described conditions. The measurement condition control signal includes at least one of a control value of the irradiation light amount or a control value of the analog/digital gain.

Then, the analysis unit 10D outputs the generated measurement condition control signal to at least one of the light source 16 or the two-dimensional photoelectric conversion sensor 28.

The light source 16 changes the irradiation light amount of the excitation light L1 so as to obtain the control value of the irradiation light amount indicated by the received measurement condition control signal. Furthermore, the two-dimensional photoelectric conversion sensor 28 changes the analog/digital gain of the A/D converter 46 so as to obtain the control value of the analog/digital gain indicated by the received measurement condition control signal.

Therefore, the analysis unit 10D may control the measurement conditions of the measurement unit 12 so as to acquire the evaluation value for deriving a more accurate analysis result of the microparticle M.

Next, an example of a flow of information processing executed by the analysis device 10 is described.

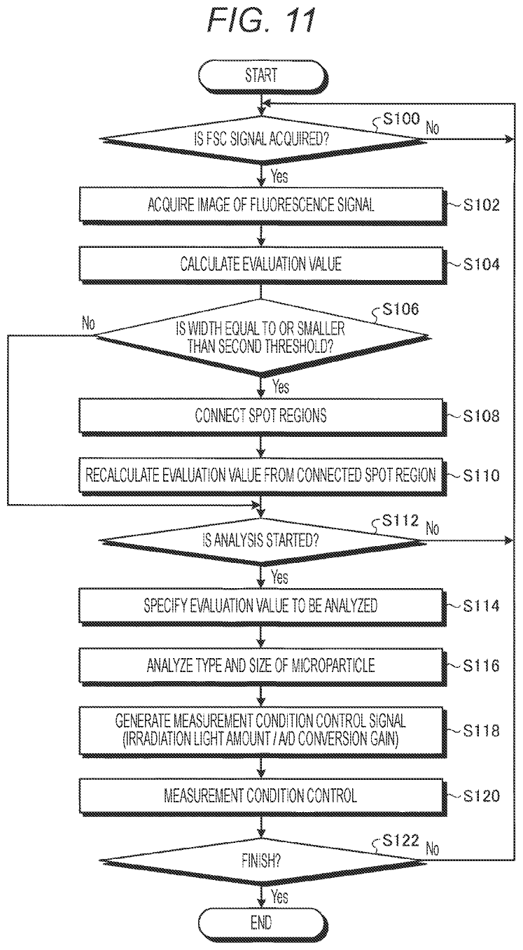

FIG. 11 is a flowchart illustrating the example of the flow of the information processing.

First, the FSC signal acquisition unit 10A determines whether or not the FSC signal is acquired from the photodiode 26 (step S100).

The FSC signal acquisition unit 10A repeats negative determination until this determines that the FSC signal is acquired (step S100: No). When the FSC signal acquisition unit 10A determines that the FSC signal is acquired (step S100: Yes), the procedure shifts to step S102.

At step S102, the fluorescence signal acquisition unit 10B acquires the image 50 of the fluorescence signal from the two-dimensional photoelectric conversion sensor 28 (step S102).

The calculation unit 10C calculates the evaluation value from the image 50 of the fluorescence signal acquired at step S102 (step S104). As described above, in this embodiment, the calculation unit 10C calculates the evaluation value including at least one of the area, the maximum value, the saturation degree, or the width from the fluorescence signal.

Next, the calculation unit 10C determines whether or not the width included in the evaluation value calculated at step S106 is equal to or smaller than the second threshold (step S106). When it is negatively determined at step S106 (step S106: No), the procedure shifts to step S112 described later.

In contrast, in a case of determining that the width is equal to or smaller than the second threshold (step S106: Yes), the calculation unit 10C generates the connected spot region obtained by connecting the spot regions S of two continuous images of the fluorescence signal (step S108).

Then, the calculation unit 10C recalculates the evaluation value from the connected spot region generated at step S108 in a manner similar to that at step S104 (step S110). Then, the procedure shifts to step S112.

At step S112, the analysis unit 10D determines whether or not to start analyzing the microparticle M (step S112). For example, the analysis unit 10D determines to start analyzing n a case where a predetermined time elapses, in a case where a predetermined number of evaluation values are obtained, in a case where a signal indicating analysis start is input by an operation instruction of a user and the like, or in a case where the evaluation value is received from the calculation unit 10C.

When it is negatively determined at step S112 (step S112: No), the procedure shifts to step S110 described above. In contrast, when it is positively determined at step S112 (step S112: Yes), the procedure shifts to step S114.

The analysis unit 10D specifies the evaluation value to be analyzed (step S114). The analysis unit 10D specifies the evaluation value to be analyzed among a plurality of evaluation values acquired by repeating processes at steps S100 to S110 described above. As described above, the analysis unit 10D generates the distribution chart illustrating the relationship between the maximum value and the area (refer to FIG. 9), and specifies the evaluation value in which at least one of the maximum value or the area falls within a predetermined range as the analysis target.

Next, the analysis unit 10D analyzes at least one of the type or the size of the microparticle M using the area included in the evaluation value to be analyzed (step S116).

Next, the analysis unit 10D generates the measurement condition control signal for controlling at least one of the light source 16 or the two-dimensional photoelectric conversion sensor 28 using the area, the maximum value, and the saturation degree included in the evaluation value to be analyzed (step S118). Then, the analysis unit 10D outputs the generated measurement condition control signal to at least one of the light source 16 or the two-dimensional photoelectric conversion sensor 28 (step S120).

By the process at step S120, at least one of the light amount of the excitation light L1 emitted from the light source 16 or a digital/analog conversion gain of the two-dimensional photoelectric conversion sensor 28 is controlled so that the image 50 of the fluorescence signal for deriving a more accurate evaluation value is acquired.

Next, the analysis unit 10D determines whether or not to finish the procedure (step S122). For example, the analysis unit 10D performs determination at step S122 by determining whether or not a signal indicating finish is received by an operation instruction by the user and the like. When it is negatively determined at step S122 (step S122: No), the procedure returns to step S100 described above. When it is positively determined at step S122 (step S122: Yes), this routine is finished.

As described above, the microparticle analysis device 1 of this embodiment is provided with the light source 16, the two-dimensional photoelectric conversion sensor 28, and the calculation unit 10C. The light source 16 irradiates the microparticle M flowing in the flow path 14C with excitation light L1. The two-dimensional photoelectric conversion sensor 28 receives the fluorescence emitted from the microparticle M by the light receiving surface 30 including a plurality of light reception units 32 arranged two-dimensionally, and acquires data of the fluorescence signal including the stored charge value of each of the plurality of light reception units 32. The calculation unit 10C calculates the evaluation value including the area that is the total value of a plurality of stored charge values included in the data of the fluorescence signal.

As described above, the microparticle analysis device 1 of this embodiment calculates the evaluation value including the area that is the total value of the plurality of stored charge values from the data of the fluorescence signal including the stored charge value.

Here, conventionally, a signal indicating fluorescence emitted from a microparticle has been acquired as a pulse waveform using a photomultiplier tube. Then, conventionally, the microparticle has been analyzed using an area, a height, and a pulse width of a pulse waveform. However, in a case where a sensor that outputs stored charge such as a CCD or a CMOS is used in place of the photomultiplier tube, the pulse waveform cannot be obtained, so that an evaluation value used for analyzing the microparticle could be obtained.

In contrast, the microparticle analysis device 1 of this embodiment uses the two-dimensional photoelectric conversion sensor 28 that acquires the data of the fluorescence signal including the stored charge value of each of the plurality of light reception units 32. Then, the microparticle analysis device 1 calculates the total value of the stored charge values included in the data of the fluorescence signal output from the two-dimensional photoelectric conversion sensor 28 as the area used for the evaluation value.

Therefore, the microparticle analysis device 1 of this embodiment may provide the evaluation value used for analyzing the microparticle M using the fluorescence signal acquired from the two-dimensional photoelectric conversion sensor 28.

Furthermore, the calculation unit 10C calculates, as the area, the total value of the subtraction results obtained by subtracting a predetermined offset value from each of the plurality of stored charge values included in the image 50 of the fluorescence signal. Therefore, the microparticle analysis device 1 of this embodiment may provide the area for analyzing the microparticle M with high accuracy as the evaluation value.

Furthermore, the calculation unit 10C calculates, as the area, the total value of the multiplication results obtained by multiplying the above-described subtraction results by a predetermined conversion gain. Therefore, the microparticle analysis device 1 of this embodiment may further provide the area for analyzing the microparticle M with higher accuracy as the evaluation value.

Furthermore, the calculation unit 10C calculates the evaluation value further including the maximum value out of the plurality of stored charge values included in the image of the fluorescence signal. Therefore, the microparticle analysis device 1 of this embodiment may provide the evaluation value that may be used for adjusting the measurement condition such as the irradiation light amount of the excitation light L1 and the analog/digital conversion gain of the two-dimensional photoelectric conversion sensor 28.

Furthermore, the calculation unit 10C calculates the evaluation value further including the saturation degree indicating the rate of the number of stored charge values indicating the maximum charge value that may be output from the light reception unit 32 included in the image 50 of the fluorescence signal. Therefore, the microparticle analysis device 1 of this embodiment may provide the evaluation value that may be used for adjusting the measurement condition such as the irradiation light amount of the excitation light L1 and the analog/digital conversion gain of the two-dimensional photoelectric conversion sensor 28.

Furthermore, the calculation unit 10C calculates the evaluation value for each spot region S being the plurality of fluorescence receiving regions included in the image 50 of the fluorescence signal. There is a case where one image 50 of the fluorescence signal includes a plurality of fluorescence spot regions S. Therefore, by calculating the evaluation value for each spot region S, the microparticle analysis device 1 may provide a highly accurate evaluation value.

Furthermore, the calculation unit 10C calculates the evaluation value further including the width being the number of pixels indicating the stored charge value equal to or larger than the first threshold out of the plurality of pixels arranged along the straight line A that passes through the center C of the spot region S included in the image 50 of the fluorescence signal. Therefore, the microparticle analysis device 1 of this embodiment may provide the evaluation value that may be used to determine the missing part of the spot region S.

Furthermore, in a case where the width is equal to or smaller than the second threshold, the calculation unit 10C recalculates the evaluation value on the basis of the connected spot region obtained by connecting the spot region S used for calculating the width and the spot region S the width of which is equal to or smaller than the second threshold included in the image 50 of the fluorescence signal acquired continuous to the fluorescence signal used for calculating the width in chronological order. Therefore, the microparticle analysis device 1 of this embodiment may accurately calculate the evaluation value even in a case where the missing part occurs in the spot region S.

The analysis unit 10D analyzes at least one of the type or the size of the microparticle M on the basis of the evaluation value. Therefore, the microparticle analysis device 1 of this embodiment may analyze at least one of the type of the microparticle M or the size of the microparticle M using the image 50 of the fluorescence signal acquired from the two-dimensional photoelectric conversion sensor 28.

Furthermore, the analysis unit 10D controls at least one of the irradiation light amount of the excitation light L1 or the analog/digital conversion gain of the two-dimensional photoelectric conversion sensor 28 on the basis of the evaluation value. Therefore, the microparticle analysis device 1 of this embodiment may control the measurement condition when measuring the microparticle M using the image 50 of the fluorescence signal acquired from the two-dimensional photoelectric conversion sensor 28.

Furthermore, the analysis unit 10D makes the evaluation value in which at least one of the maximum value or the area falls within a predetermined range among the plurality of evaluation values the analysis target. Therefore, the microparticle analysis device 1 of this embodiment may analyze the microparticle M with high accuracy and control the measurement condition when measuring the microparticle M with high accuracy.

Furthermore, the analysis device 10 of this embodiment is provided with the fluorescence signal acquisition unit 10B, the calculation unit 10C, and the analysis unit 10D. The calculation unit 10C acquires the fluorescence signal from the two-dimensional photoelectric conversion sensor 28 that receives the fluorescence emitted from the microparticle M by the light receiving surface 30 including the plurality of light reception units 32 arranged two-dimensionally and outputs the image 50 of the fluorescence signal including the stored charge value of each of the plurality of light reception units 32. The calculation unit 10C calculates the evaluation value including the area that is the total value of the plurality of stored charge values included in the image 50 of the fluorescence signal. The analysis unit 10D analyzes at least one of the type or the size of the microparticle M on the basis of the evaluation value.

Therefore, the analysis device 10 of this embodiment may analyze the microparticle M using the image 50 of the fluorescence signal acquired from the two-dimensional photoelectric conversion sensor 28.

[Variation]

Note that, in the above-described embodiment, a case where the analysis device 10 is provided with the FSC signal acquisition unit 10A, the fluorescence signal acquisition unit 10B, the calculation unit 10C, and the analysis unit 10D is described as an example.

However, in the analysis device 10, at least one of the FSC signal acquisition unit 10A, the fluorescence signal acquisition unit 10B, the calculation unit 10C, or the analysis unit 10D may be configured as a separate body. For example, the FSC signal acquisition unit 10A, the fluorescence signal acquisition unit 10B, and the calculation unit 10C may be formed as one device, and the analysis unit 10D may be formed as another device. In this case, the device including the analysis unit 10D may acquire an evaluation value from the device including the calculation unit 10C and use the same for analyzing a microparticle M.

Note that, although the embodiment and the variation of the present disclosure are described above, the processing according to the embodiment and the variation described above may be embodied in various different modes other than the embodiment and the variation described above. Furthermore, the above-described embodiment and variation may be appropriately combined within a range in which the processing contents are consistent.

Furthermore, the effect described in this specification is illustrative only; the effect is not limited thereto and there may also be another effect.

(Hardware Configuration)

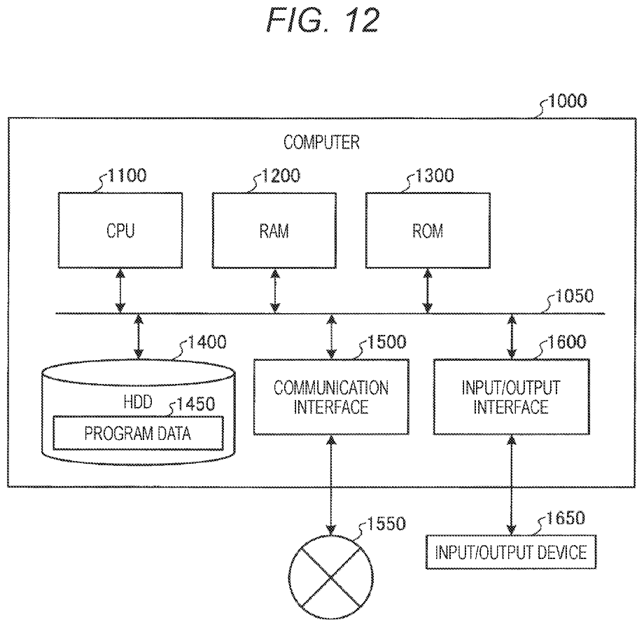

FIG. 12 is a hardware configuration diagram illustrating an example of a computer 1000 that implements functions of the analysis device 10 according to the embodiment and the variation described above.

The computer 1000 includes a CPU 1100, a RAM 1200, a read only memory (ROM) 1300, a hard disk drive (HDD) 1400, a communication interface 1500, and an input/output interface 1600. The units of the computer 1000 are connected to each other by a bus 1050.

The CPU 1100 operates on the basis of a program stored in the ROM 1300 or the HDD 1400, and controls each unit. For example, the CPU 1100 develops the program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000 and the like.

The HDD 1400 is a computer-readable recording medium that non-transiently records the program executed by the CPU 1100, data used by the program and the like. Specifically, the HDD 1400 is a recording medium that records an image processing program according to the present disclosure as an example of a program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 to the computer 1000. For example, the CPU 1100 receives data from an input device such as a keyboard and a mouse via the input/output interface 1600. Furthermore, the CPU 1100 transmits data to an output device such as a display, a speaker, and a printer via the input/output interface 1600. Furthermore, the input/output interface 1600 may serve as a media interface that reads a program and the like recorded in a predetermined recording medium (medium). The medium is, for example, an optical recording medium such as a digital versatile disc (DVD) and a phase change rewritable disk (PD), a magneto-optical recording medium such as a magneto-optical disk (MO), a tape medium, a magnetic recording medium, a semiconductor memory or the like.

For example, in a case where the computer 1000 serves as the analysis device 10 according to the above-described embodiment, the CPU 1100 of the computer 1000 executes an information processing program loaded on the RAM 1200 to implement functions of the FSC signal acquisition unit 10A and the like. Furthermore, the HDD 1400 stores programs and data according to the present disclosure. Note that the CPU 1100 reads the program data 1450 from the HDD 1400 to execute, but as another example, these programs may be acquired from another device via the external network 1550.

Note that the present technology may also have following configurations.

(1)

A microparticle analysis device provided with:

a light source that irradiates a microparticle flowing in a flow path with excitation light;

a two-dimensional photoelectric conversion sensor that receives fluorescence emitted from the microparticle by a light receiving surface including a plurality of light reception units arranged two-dimensionally and acquires data of a fluorescence signal including stored charge values of a plurality of the light reception units, respectively; and

a calculation unit that calculates an evaluation value including an area that is a total value of a plurality of the stored charge values included in the data of the fluorescence signal.

(2)

The microparticle analysis device according to (1) described above, in which

the calculation unit calculates, as the area, the total value of subtraction results obtained by subtracting a predetermined offset value from each of a plurality of the stored charge values included in an image of the fluorescence signal.

(3)

The microparticle analysis device according to (2) described above, in which

the calculation unit calculates, as the area, the total value of multiplication results obtained by multiplying the subtraction results by a predetermined conversion gain.

(4)

The microparticle analysis device according to any one of (1) to (3) described above, in which

the calculation unit calculates the evaluation value further including a maximum value out of a plurality of the stored charge values included in an image of the fluorescence signal.

(5)

The microparticle analysis device according to any one of (1) to (4) described above, in which

the calculation unit calculates the evaluation value further including a saturation degree indicating a rate of the number of the stored charge values indicating a maximum charge value that may be output from the light reception units included in an image of the fluorescence signal.

(6)

The microparticle analysis device according to any one of (1) to (5) described above, in which

an image of the fluorescence signal is an image that defines the stored charge values for pixels corresponding to a plurality of the light reception units, respectively, and

the calculation unit calculates the evaluation value for each of spot regions that are a plurality of fluorescence receiving regions included in the image of the fluorescence signal.

(7)

The microparticle analysis device according to (6) described above, in which

the calculation unit calculates the evaluation value further including a width that is the number of the pixels indicating the stored charge values equal to or larger than a first threshold out of a plurality of the pixels arranged along a straight line that passes through a center of the spot region included in the image of the fluorescence signal.

(8)

The microparticle analysis device according to (7) described above, in which

the calculation unit recalculates,

in a case where the width is equal to or smaller than a second threshold,

the evaluation value on the basis of a connected spot region obtained by connecting the spot region used for calculating the width and the spot region having the width equal to or smaller than the second threshold included in the image of the fluorescence signal acquired continuous to the image of the fluorescence signal used for calculating the width in chronological order.

(9)

The microparticle analysis device according to any one of (1) to (8) described above, provided with:

an analysis unit that analyzes at least one of a type or a size of the microparticle on the basis of the evaluation value.

(10)

The microparticle analysis device according to (9) described above, in which

the analysis unit controls at least one of an irradiation light amount of the excitation light or an analog/digital conversion gain of the two-dimensional photoelectric conversion sensor on the basis of the evaluation value.

(11)

The microparticle analysis device according to (9) described above, in which

the analysis unit makes the evaluation value indicating a value within a predetermined range out of a plurality of evaluation values an analysis target.

(12)

An analysis device provided with:

a fluorescence signal acquisition unit that acquires, from a two-dimensional photoelectric conversion sensor that receives fluorescence emitted from a microparticle by a light receiving surface including a plurality of light reception units arranged two-dimensionally and outputs an image of a fluorescence signal including stored charge values of a plurality of the light reception units, respectively, the image of the fluorescence signal;

a calculation unit that calculates an evaluation value including an area that is a total value of a plurality of the stored charge values included in the image of the fluorescence signal; and

an analysis unit that analyzes at least one of a type or a size of the microparticle on the basis of the evaluation value.

(13)

An analysis program that allows a computer to execute steps of:

acquiring, from a two-dimensional photoelectric conversion sensor that receives fluorescence emitted from a microparticle by a light receiving surface including a plurality of light reception units arranged two-dimensionally and outputs an image of a fluorescence signal including stored charge values of a plurality of the light reception units, respectively, the image of the fluorescence signal;

calculating an evaluation value including an area that is a total value of a plurality of the stored charge values included in the image of the fluorescence signal; and

analyzing at least one of a type or a size of the microparticle on the basis of the evaluation value.

(14)

A microparticle analysis system provided with:

a measurement unit; and

software used to control an operation of the measurement unit,

the software installed in an information processing device, in which

the measurement unit includes:

a light source that emits excitation light into a flow path in which a microparticle flows; and

a two-dimensional photoelectric conversion sensor that receives fluorescence emitted from the microparticle by a light receiving surface including a plurality of light reception units arranged two-dimensionally and outputs an image of a fluorescence signal including stored charge values of a plurality of the light reception units, respectively, and

the software

calculates an evaluation value including at least one of an area that is a total value of a plurality of the stored charge values included in the image of the fluorescence signal, a maximum value among a plurality of the stored charge values included in the image of the fluorescence signal, or a saturation degree indicating a rate of the number of the stored charge values indicating a maximum charge value that may be output from the light reception units included in the image of the fluorescence signal, and

controls at least one of an irradiation light amount of the excitation light emitted from the light source or an analog/digital conversion gain of the two-dimensional photoelectric conversion sensor on the basis of the evaluation value.

### REFERENCE SIGNS LIST

1 Microparticle analysis device
10B Fluorescence signal acquisition unit
10C Calculation unit
10D Analysis unit
12 Measurement unit
16 Light source
28 Two-dimensional photoelectric conversion sensor
30 Light receiving surface
32 Light reception unit
50 Image of fluorescence signal

1. A microparticle analysis device comprising:
a light source that irradiates a microparticle flowing in a flow path with excitation light;
a two-dimensional photoelectric conversion sensor that receives fluorescence emitted from the microparticle by a light receiving surface including a plurality of light reception units arranged two-dimensionally and acquires data of a fluorescence signal including stored charge values of a plurality of the light reception units, respectively; and
a calculation unit that calculates an evaluation value including an area that is a total value of a plurality of the stored charge values included in the data of the fluorescence signal.

2. The microparticle analysis device according to claim 1, wherein
the calculation unit calculates, as the area, the total value of subtraction results obtained by subtracting a predetermined offset value from each of a plurality of the stored charge values included in an image of the fluorescence signal.

3. The microparticle analysis device according to claim 2, wherein
the calculation unit calculates, as the area, the total value of multiplication results obtained by multiplying the subtraction results by a predetermined conversion gain.

4. The microparticle analysis device according to claim 1, wherein
the calculation unit calculates the evaluation value further including a maximum value out of a plurality of the stored charge values included in an image of the fluorescence signal.

5. The microparticle analysis device according to claim 1, wherein
the calculation unit calculates the evaluation value further including a saturation degree indicating a rate of a number of the stored charge values indicating a maximum charge value that may be output from the light reception units included in an image of the fluorescence signal.

6. The microparticle analysis device according to claim 1, wherein
an image of the fluorescence signal is an image that defines the stored charge values for pixels corresponding to a plurality of the light reception units, respectively, and
the calculation unit calculates the evaluation value for each of spot regions that are a plurality of fluorescence receiving regions included in the image of the fluorescence signal.

7. The microparticle analysis device according to claim 6, wherein
the calculation unit calculates the evaluation value further including a width that is a number of the pixels indicating the stored charge values equal to or larger than a first threshold out of a plurality of the pixels arranged along a straight line that passes through a center of the spot region included in the image of the fluorescence signal.

8. The microparticle analysis device according to claim 7, wherein
the calculation unit recalculates,
in a case where the width is equal to or smaller than a second threshold,
the evaluation value on a basis of a connected spot region obtained by connecting the spot region used for calculating the width and the spot region having the width equal to or smaller than the second threshold included in the image of the fluorescence signal acquired continuous to the image of the fluorescence signal used for calculating the width in chronological order.

9. The microparticle analysis device according to claim 1, comprising:
an analysis unit that analyzes at least one of a type or a size of the microparticle on a basis of the evaluation value.

10. The microparticle analysis device according to claim 9, wherein
the analysis unit controls at least one of an irradiation light amount of the excitation light or an analog/digital conversion gain of the two-dimensional photoelectric conversion sensor on a basis of the evaluation value.

11. The microparticle analysis device according to claim 9, wherein
the analysis unit makes the evaluation value indicating a value within a predetermined range out of a plurality of evaluation values an analysis target.

12. An analysis device comprising:
a fluorescence signal acquisition unit that acquires, from a two-dimensional photoelectric conversion sensor that receives fluorescence emitted from a microparticle by a light receiving surface including a plurality of light reception units arranged two-dimensionally and outputs an image of a fluorescence signal including stored charge values of a plurality of the light reception units, respectively, the image of the fluorescence signal;
a calculation unit that calculates an evaluation value including an area that is a total value of a plurality of the stored charge values included in the image of the fluorescence signal; and
an analysis unit that analyzes at least one of a type or a size of the microparticle on a basis of the evaluation value.

13. An analysis program that allows a computer to execute steps of:
acquiring, from a two-dimensional photoelectric conversion sensor that receives fluorescence emitted from a microparticle by a light receiving surface including a plurality of light reception units arranged two-dimensionally and outputs an image of a fluorescence signal including stored charge values of a plurality of the light reception units, respectively, the image of the fluorescence signal;
calculating an evaluation value including an area that is a total value of a plurality of the stored charge values included in the image of the fluorescence signal; and
analyzing at least one of a type or a size of the microparticle on a basis of the evaluation value.

14. A microparticle analysis system comprising:
a measurement unit; and
software used to control an operation of the measurement unit,
the software installed in an information processing device, wherein
the measurement unit includes:
a light source that emits excitation light into a flow path in which a microparticle flows; and
a two-dimensional photoelectric conversion sensor that receives fluorescence emitted from the microparticle by a light receiving surface including a plurality of light reception units arranged two-dimensionally and outputs an image of a fluorescence signal including stored charge values of a plurality of the light reception units, respectively, and
the software
calculates an evaluation value including at least one of an area that is a total value of a plurality of the stored charge values included in the image of the fluorescence signal, a maximum value among a plurality of the stored charge values included in the image of the fluorescence signal, or a saturation degree indicating a rate of a number of the stored charge values indicating a maximum charge value that may be output from the light reception units included in the image of the fluorescence signal, and
controls at least one of an irradiation light amount of the excitation light emitted from the light source or an analog/digital conversion gain of the two-dimensional photoelectric conversion sensor on a basis of the evaluation value.
